(19) United States
(12) Patent Application Publication
(10) Pub. No.: US 2026/0360333 A1
(43) Pub. Date: Nov. 12, 2026

(54) DISPLAY DEVICE AND IMAGE PROCESSING METHOD

(71) Applicant: SAMSUNG ELECTRONICS CO., LTD., Suwon-si (KR)

(72) Inventors: Sehyeok PARK, Suwon-si (KR); Seongwoon JUNG, Suwon-si (KR)

(73) Assignee: SAMSUNG ELECTRONICS CO., LTD., Suwon-si (KR)

(21) Appl. No.: 19/733,304

(22) Filed: Jul. 7, 2026

Related U.S. Application Data
(63) Continuation of application No. PCT/KR2024/020689, filed on Dec. 19, 2024.

(30) Foreign Application Priority Data
Jan. 29, 2024 (KR) 10-2024-0012895

(51) Int. Cl. G09G 5/10

(52) U.S. Cl. CPC G09G 5/10; G09G 2320/0606; G09G 2320/0666; G09G 2354/00; G09G 2360/14

(57) ABSTRACT

A display device includes memory and at least one processor configured to estimate a color temperature of at least one external light source based on detection; and perform color reproduction calibration by adjusting brightness, color temperature, contrast, color, saturation, or sharpness of an output image, increasing the color reproduction rate relative to input image data. First color reproduction modeling data comprises reproduction color data of a reference color panel corresponding to standard light sources defined by the International Commission on Illumination (CIE A, CIE F2, CIE D50, CIE D65, or CIE D75). Second color reproduction modeling data comprises reproduction color data corresponding to reflection characteristics of the display panel under predetermined illumination conditions. The device may enter an art gallery mode based on image identification or user input and perform calibration according to user settings including sharpness, light source type, reflectance, and viewing angle.

### CROSS-REFERENCE TO RELATED APPLICATION

This application is a by-pass continuation application of International Application No. PCT/KR2024/020689, filed on Dec. 19, 2024, which is based on and claims priority to Korean Patent Application No. 10-2024-0012895, filed on Jan. 29, 2024 , in the Korean Intellectual Property Office, the disclosures of which are incorporated by reference herein in their entireties.

### 1. FIELD

Various embodiments of the disclosure relate to a display device, a display device performing color reproduction calibration, and an image processing method for performing color reproduction calibration.

### 2. DESCRIPTION OF RELATED ART

With the development of digital technology, various types of electronic devices such as smart TVs, smart phones, tablet PCs, electronic notebooks, personal digital assistant (PDA), or wearable devices, are available for use. These types of electronic devices can be implemented as a display device that outputs images on a display panel based on input data.

With continuous technological advances with display devices, display devices nowadays not only provide simple image display functions but also provide various functions for optimal viewing environment. For example, when an output image based on input image data is displayed, a display device may adjust the brightness of an image by take into consideration lighting factors, such as ambient light of the surrounding environment and the sunlight.

In the related art, existing display devices may not sufficiently consider the illumination characteristics of the surrounding environment, and because the existing display devices do not adjust image quality according to color temperature, a problem of decrease in color consistency under various lighting conditions occurs. Therefore, an image quality adjustment technique is needed that can prevent the problem of reproduction color of the display device changing according to the change of color temperature among the illumination characteristics of the surrounding environment.

### SUMMARY

According to an aspect of the disclosure, a display device includes memory storing one or more instructions; and at least one processor connected to the memory, wherein the one or more instructions, when executed by the at least one processor individually or collectively, cause the display device to estimate a color temperature of at least one external light source, based on detecting the at least one external light source; and perform, based on first color reproduction modeling data the color temperature of the at least one external light source, a color reproduction calibration by adjusting at least one of brightness, color temperature, contrast, color, saturation, or sharpness of the output image, obtaining the output image having a color reproduction rate that is increased relative to the input image data.

The display device may include wherein the first color reproduction modeling data comprises first reproduction color data of a reference color panel, the first reproduction color data corresponding to an illumination condition of at least one standard light source defined by the International Commission on Illumination (CIE).

The display device may include wherein the at least one standard light source comprises at least one of CIE A, CIE F2, CIE D50, CIE D65, or CIE D75.

The display device may include wherein the reference color panel comprises at least 24 color patches having different color values from each other.

The display device may include wherein the one or more instructions, when executed by the at least one processor individually or collectively, further cause the display device to perform, based on a reflection characteristic of a display panel and second color reproduction modeling data, a color reproduction calibration, wherein the second color reproduction modeling data comprises second reproduction color data of the reference color panel, the second reproduction color data corresponding to the reflection characteristic of the display panel under a predetermined illumination condition.

The display device may include wherein the reflection characteristic comprises at least one of a reflectance or a viewing angle of the display panel.

The display device may include wherein the one or more instructions, when executed by the at least one processor individually or collectively, further cause the display device to enter an art gallery mode based on identifying an art gallery image from the input image data; and perform the color reproduction calibration for the art gallery image based on at least one of the first color reproduction modeling data or the second color reproduction modeling data.

The display device may include wherein the one or more instructions, when executed by the at least one processor individually or collectively, further cause the display device to enter an art gallery mode based on a user input; and perform the color reproduction calibration for an art gallery image based on a user setting.

The display device may include wherein the one or more instructions, when executed by the at least one processor individually or collectively, further cause the display device to receive the user input from an external control device, and wherein the external control device comprises a hot-key for entering the art gallery mode.

The display device may include wherein the one or more instructions, when executed by the at least one processor individually or collectively, further cause the display device to provide a user interface for changing the user setting of the art gallery mode, the user setting comprising at least one of a sharpness, a light source type, a reflectance, or a viewing angle.

According to another aspect of the disclosure, an image processing method for color reproduction calibration includes generating first color reproduction modeling data, by modeling a reproduction color according to a type of light source; generating second color reproduction modeling data, by modeling a reproduction color according to a reflection characteristic of a display panel; estimating a color temperature of at least one external light source, based on detecting the at least one external light source; and performing, based on at least one of the first color reproduction modeling data and the second color reproduction modeling data, a color reproduction calibration by adjusting at least one of brightness, color temperature, contrast, color, saturation, or sharpness of the output image, obtaining the output image having a color reproduction rate that is increased relative to the input image data.

The image processing method may include wherein the generating of the first color reproduction modeling data comprises modeling a reproduction color of a reference color panel, the first color reproduction modeling data including first reproduction color data corresponding to an illumination condition of at least one standard light source defined by the International Commission on Illumination (CIE).

The image processing method may include wherein the at least one standard light source comprises at least one of CIE A, CIE F2, CIE D50, CIE D65, or CIE D75.

The image processing method may include wherein the reference color panel comprises at least 24 color patches having different color values from each other.

The image processing method may include wherein the generating of the second color reproduction modeling data comprises modeling a reproduction color of the reference color panel, the second color reproduction modeling data including second reproduction color data corresponding to the reflection characteristic of the display panel under a predetermined illumination condition.

### BRIEF DESCRIPTION OF THE DRAWINGS

FIG. 1 is a view illustrating a block configuration of an image processing apparatus according to an embodiment of the disclosure.

FIG. 2 is a view illustrating a block configuration of a display device according to an embodiment of the disclosure.

FIG. 3 is a view illustrating an operation sequence of a display device according to an embodiment of the disclosure.

FIG. 4 is a view illustrating a display device that displays an output image under a predetermined illumination condition according to an embodiment of the disclosure.

FIG. 5A is a view illustrating areas corresponding to respective colors on a LAB color space according to an embodiment of the disclosure.

FIG. 5B is a view illustrating areas of standard light sources according to an embodiment of the disclosure.

FIG. 6 is a view illustrating a measurement device and a reference color panel used for color reproduction modeling according to an embodiment of the disclosure.

FIG. 7 is a view illustrating a display operation based on color reproduction calibration according to an embodiment of the disclosure.

FIG. 8 is a view illustrating an operation sequence of a display device according to an embodiment of the disclosure.

FIG. 9 is a view illustrating a reflection characteristic of a display device according to an embodiment of the disclosure.

FIG. 10 is a view illustrating a display operation based on color reproduction calibration according to an embodiment of the disclosure.

FIG. 11 is a view illustrating an art gallery mode of a display device according to an embodiment of the disclosure.

FIG. 12 is a view illustrating an operation sequence of a display device in case that an art gallery mode is automatically entered.

FIG. 13 is a view illustrating an operation sequence of a display device in case that an art gallery mode is manually entered.

FIG. 14 is a view illustrating a control device that controls a display device according to an embodiment of the disclosure.

FIG. 15 is a view illustrating a user interface of a display device according to an embodiment of the disclosure.

FIG. 16 is a view illustrating an image processing method for color reproduction calibration according to an embodiment of the disclosure.

### DETAILED DESCRIPTION

Hereinafter, with reference to the drawings, embodiments of the disclosure will be described in detail so that those skilled in the art to which the disclosure belongs can easily carry out the embodiments. However, the disclosure may be implemented in various different forms and is not limited to the embodiments described herein. In connection with the description of the drawings, the same or similar reference signs may be used for the same or similar components. Also, in the drawings and related description, descriptions of well-known functions and configurations may be omitted for clarity and conciseness.

Here, it will be understood that each block of the processing flowchart drawings and combinations of the flowchart drawings may be performed by computer program instructions.

Furthermore, each block may represent a module, segment, or portion of code containing one or more executable instructions for executing specified logical function(s). Further, it should be noted that in some alternative execution examples, the functions mentioned in the blocks may occur out of order. For example, two blocks shown in succession may, in fact, be executed substantially concurrently, or the blocks may sometimes be executed in reverse order, depending on the corresponding function.

In this embodiment, the term ‘unit’ used in the present embodiment refers to a software or hardware component such as Field Programmable Gate Array (FPGA) or Application Specific Integrated Circuit (ASIC), and ‘unit’ performs certain roles. However, ‘unit’ is not limited to software or hardware. ‘unit’ may be configured to be in an addressable storage medium or may be configured to reproduce one or more packet processing devices. Accordingly, as an example, ‘unit’ includes components such as software components, object-oriented software components, class components and task components, processes, functions, properties, procedures, subroutines, segments of program code, drivers, firmware, microcode, circuits, data, databases, data structures, tables, arrays, and variables. Components and functions provided in ‘unit’s may be combined into a smaller number of components and ‘unit’s or may be further separated into additional components and ‘unit’s. Furthermore, the components and ‘unit’s may be implemented to reproduce one or more central processing units (CPUs) in a device or a secure multimedia card. Further, in an embodiment, ‘unit’ may include one or more packet processing devices.

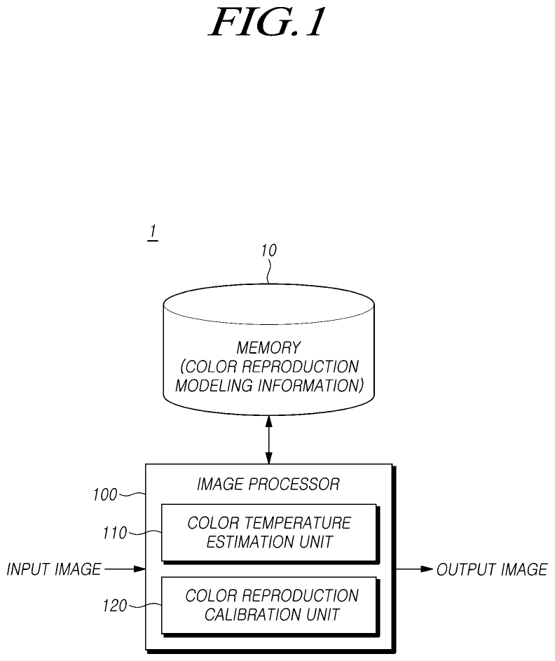

FIG. 1 illustrates a block configuration of an image processing apparatus according to an embodiment of the disclosure.

The image processing apparatus 1 may increase color reproduction accuracy of an output image by performing image quality adjustment. For example, the image processing apparatus 1 may estimate color temperature of an ELS and may increase color reproduction accuracy of the output image by adaptively performing color reproduction calibration based on the color temperature of the ELS. For example, the image processing apparatus 1 may increase color reproduction accuracy of the output image by performing color reproduction calibration optimized to a reflection characteristic of a display panel.

Referring to FIG. 1, the image processing apparatus 1 may include a memory 10 and/or an image processor 100.

According to an embodiment, the memory 10 may store information (color reproduction modeling information) regarding settings for image processing of the image processing apparatus 1. The color reproduction modeling information may include, for example, at least one of first color reproduction modeling data of a Reference Color Pattern(RCP) based on illumination conditions of at least one standard light source or second color reproduction modeling data of the RCP based on a reflection characteristic of a display panel under a predetermined illumination condition, but is not limited thereto.

According to an embodiment, the image processor 100 may perform image processing on an input image based on color reproduction modeling information stored in the memory 10 and obtain an output image.

According to an embodiment, the image processor 100 may include a color temperature estimation unit 110 and a color reproduction calibration unit 120.

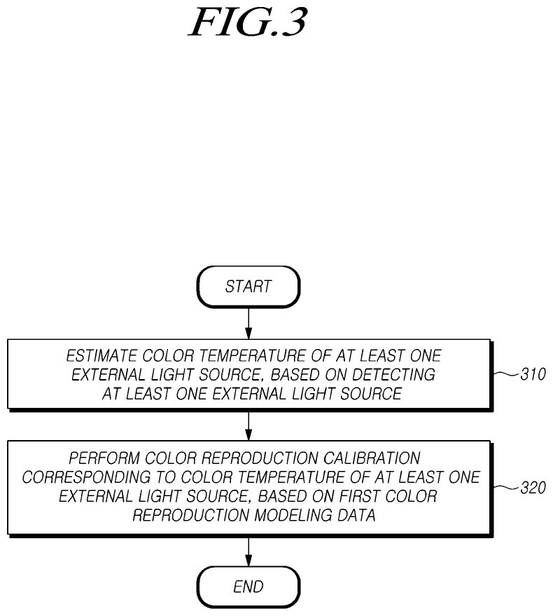

According to an embodiment, the color temperature estimation unit 110 may estimate color temperature of at least one ELS based on sensing data. For example, the color temperature estimation unit 110 may detect at least one ELS using at least one light source sensor. For example, the color temperature estimation unit 110 may generate sensing data regarding at least one ELS and may estimate color temperature of at least one ELS based on the sensing data. The operation of the color temperature estimation unit 110 is described below by way of example with reference to FIGS. 3 to 7.

According to an embodiment, the color reproduction calibration unit 120 may perform image processing for image quality adjustment on the input image based on the color reproduction modeling information stored in the memory 10. For example, the color reproduction calibration unit 120 may generate an output image with color reproduction calibration applied. The operation of the color reproduction calibration unit 120 is described below by way of example with reference to FIGS. 3 to 10.

As such, the image processing apparatus according to the disclosure may accurately reproduce colors of input image even in various illumination environments, to increase color reproduction accuracy of an output image. As a result, the image processing apparatus according to the disclosure may provide an improved visual experience to a user.

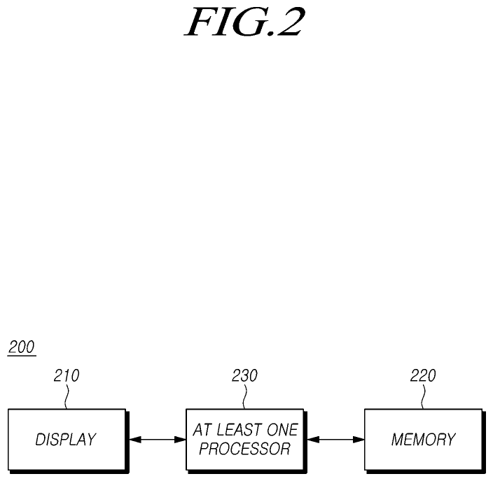

FIG. 2 illustrates a block configuration of a display device according to an embodiment of the disclosure.

Referring to FIG. 2, the display device 200 may include a display 210, a memory 220, and one or more processors 230.

According to an embodiment, the display 210 may be implemented with various types of displays such as, for example, LCD (liquid crystal display), OLED (organic light-emitting diode), LCoS (Liquid Crystal on Silicon), DLP (Digital Light Processing), QD (quantum dot) display panel, QLED (quantum dot light-emitting diodes), μLED (Micro light-emitting diodes), Mini LED, and the like.

According to an embodiment, the display device 200 may be implemented with, for example, a touch screen combined with a touch sensor, a flexible display, a rollable display, a three-dimensional (3D) display, or a display in which a plurality of display modules are physically connected.

According to an embodiment, the memory 220 may store data necessary for various embodiments of the disclosure. The memory 220 may be implemented in the form of a memory embedded in the display device 200 or may be implemented in the form of a memory detachable from the display device 200, depending on the purpose of data storage. For example, data for driving the display device 200 may be stored in a memory embedded in the display device 200, and data for expansion functions of the display device 200 may be stored in a memory detachable from the display device 200. Meanwhile, in the case of a memory embedded in the display device 200, the embedded memory may be implemented as at least one of a volatile memory (for example, DRAM (dynamic RAM), SRAM (static RAM), or SDRAM (synchronous dynamic RAM), and the like), a non-volatile memory (for example, OTPROM (one time programmable ROM), PROM (programmable ROM), EPROM (erasable and programmable ROM), EEPROM (electrically erasable and programmable ROM), mask ROM, flash ROM, flash memory (for example, NAND flash or NOR flash, and the like), a hard drive, or a solid state drive (SSD)). Further, in the case of a memory detachable from the display device 200, a memory card (for example, CF (compact flash), SD (secure digital), Micro-SD (micro secure digital), Mini-SD (mini secure digital), xD (extreme digital), MMC (multi-media card), and the like), an external memory connectable to a USB port (for example, USB memory), and the like may be implemented.

According to an example, the memory 220 may store at least one instruction for controlling the display device 200 or a computer program including instructions.

According to an embodiment, various data may be stored in an external memory of the processor 230, or some of the data may be stored in an internal memory of the processor 230 and the remainder may be stored in an external memory.

According to an embodiment, at least one processor 230 may control overall operations of the display device 200.

According to an embodiment, the processor 230 may be implemented as a digital signal processor (DSP), a microprocessor, or a timing controller (TCON) that processes digital signals. However, it is not limited thereto, and may include one or more of a central processing unit (CPU), micro controller unit, micro processing unit, controller, application processor, or communication processor, ARM processor, AI (artificial intelligence) processor, or may be defined by the corresponding term. The processor 230 may be implemented as a system on chip (SoC) with a built-in processing algorithm, large scale integration, or in the form of FPGA. The processor 230 may perform various functions by executing computer executable instructions stored in memory.

The processor 230 may include one or more of a CPU, graphics processing unit (GPU), accelerated processing unit (APU), many integrated core (MIC), DSP, neural processing unit (NPU), hardware accelerator, or machine learning accelerator. The processor 230 may control one or any combination of other components of the display device 200 and may perform operations related to communication or data processing. The processor 230 may execute one or more programs or instructions stored in memory. For example, the processor 230 may perform a method according to an embodiment of the disclosure by executing one or more instructions stored in memory.

According to an embodiment, in case the method includes a plurality of operations, the plurality of operations may be performed by one processor or by a plurality of processors. For example, in case a first operation, a second operation, and a third operation are performed according to a method of an embodiment, the first operation, the second operation, and the third operation may all be performed by a first processor, or the first operation and the second operation may be performed by the first processor (for example, a general-purpose processor) and the third operation may be performed by a second processor (for example, an artificial intelligence dedicated processor).

The processor 230 may be implemented as a single core processor comprising one core or may be implemented as one or more multicore processors comprising a plurality of cores (for example, homogeneous multicore or heterogeneous multicore). In the event that the processor 230 is implemented as a multicore processor, each of the plurality of cores included in the multicore processor may include processor internal memory such as cache memory and on-chip memory, and a common cache shared by the plurality of cores may be included in the multicore processor. Further, each of the plurality of cores included in the multicore processor (or some of the plurality of cores) may independently read and execute program instructions for implementing a method according to an embodiment of the disclosure, or the plurality of cores (or some thereof) may be linked to read and execute program instructions for implementing a method according to an embodiment of the disclosure.

In case the method according to an embodiment includes a plurality of operations, the plurality of operations may be performed by one of the plurality of cores included in the multicore processor or by the plurality of cores. For example, in case a first operation, a second operation, and a third operation are performed according to a method of an embodiment, the first operation, the second operation, and the third operation may all be performed by a first core included in the multicore processor, or the first operation and the second operation may be performed by a first core included in the multicore processor and the third operation may be performed by a second core included in the multicore processor.

In various embodiments of the disclosure, the processor 230 may refer to a SoC in which one or more processors and other electronic components are integrated, a single core processor, a multicore processor, or a core included in a single core processor or a multicore processor, where the core may be implemented as a CPU, GPU, APU, MIC, DSP, NPU, hardware accelerator, or machine learning accelerator, but embodiments of the disclosure are not limited thereto.

According to an embodiment, the image processing apparatus 1 of FIG. 1 may be included in the display device 200 of FIG. 2, may be the display device 200, or may include the display device 200. For example, in case the image processing apparatus 1 of FIG. 1 is included in the display device 200 of FIG. 2, the memory 10 of the image processing apparatus 1 of FIG. 1 may be included in the memory 220 of the display device 200 of FIG. 2, and the image processor 100 of the image processing apparatus 1 of FIG. 1 may be included in at least one processor 230 of the display device 200 of FIG. 2.

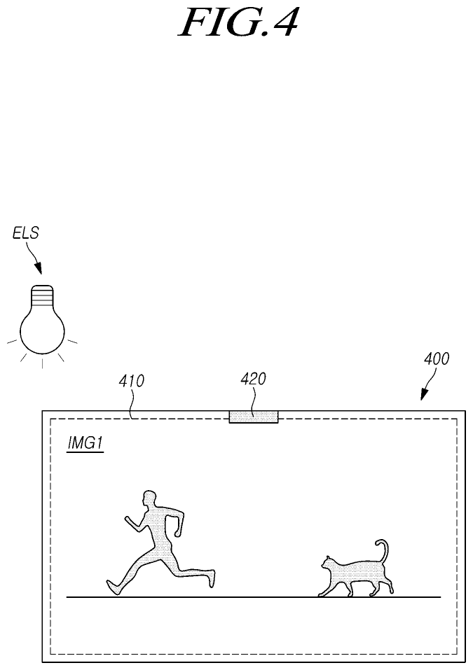

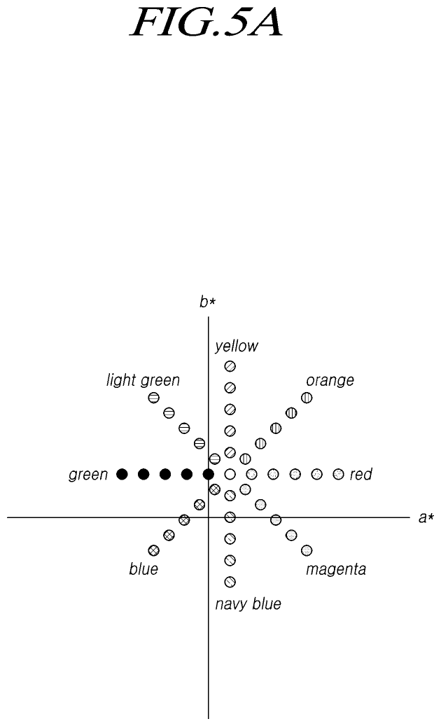

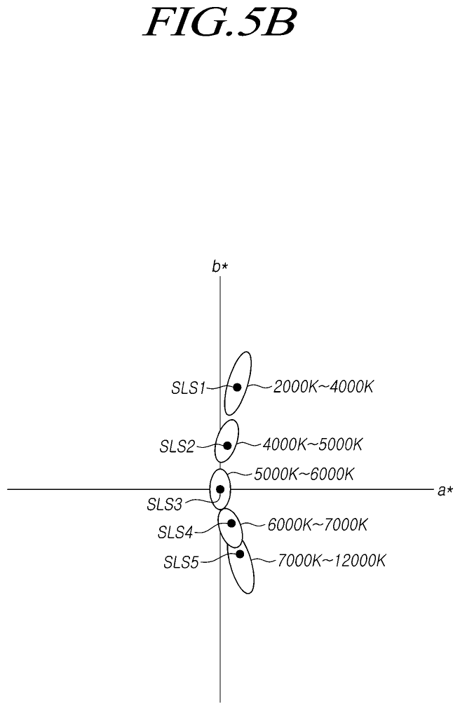

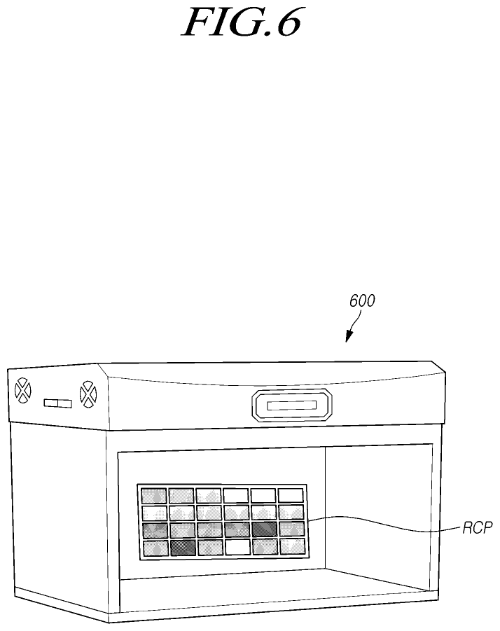

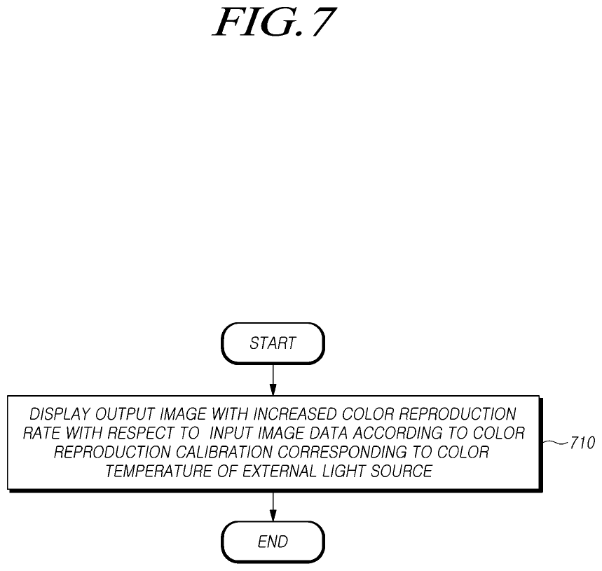

FIG. 3 illustrates an operation sequence of the display device 400 according to an embodiment of the disclosure, FIG. 4 illustrates the display device 400 displaying an output image under a predetermined illumination condition according to an embodiment of the disclosure, FIG. 5A illustrates regions corresponding to respective colors on a LAB color space according to an embodiment of the disclosure, FIG. 5B illustrates regions of a standard light source according to an embodiment of the disclosure, and FIG. 6 illustrates a measurement device 600 and a RCP used in color reproduction modeling according to an embodiment of the disclosure. FIG. 7 illustrates display operation based on color reproduction calibration according to an embodiment of the disclosure.

Referring to FIGS. 3 to 7, the display device 400 may detect at least one ELS and estimate (operation 310) color temperature of at least one ELS and perform (operation 320) color reproduction calibration corresponding to the color temperature of at least one ELS based on first color reproduction modeling data.

According to an example, in operation 310, the display device 400 may estimate color temperature of at least one ELS based on detecting at least one ELS. For example, the display device 400 may display an output image based on input image data under a predetermined illumination condition. The predetermined illumination condition may include at least one ELS. At least one ELS may have a predetermined color temperature.

As shown in FIG. 4, the display device 400 may include a light source sensor 420. For example, the light source sensor 420 may include at least one of a photodiode sensor, a phototransistor sensor, a photovoltaic sensor, a CCD sensor, or a CMOS sensor. The light source sensor 420 may detect color composition and color ratio of at least one ELS by performing spectral analysis on at least one ELS. The light source sensor 420 may generate sensing data by detecting at least one ELS.

The display device 400 may estimate a color temperature of at least one ELS based on the sensing data. The display device 400 may estimate an area corresponding to a color of at least one ELS on a LAB color space. Referring to FIG. 5A, coordinates corresponding to each color on a LAB color space may be defined. The LAB color space may represent brightness and color of a color on a color space implemented with an L-axis, an a-axis, and a b-axis as positional information. The L-axis may represent brightness as positional information. The a-axis and b-axis may represent a predetermined color as positional information. For example, the a-axis may represent a color ranging from green to red. For example, the b-axis may represent a color ranging from blue to yellow. In FIGS. 5A and 5B, the L-axis is omitted. The display device 400 may classify at least one ELS into at least one standard light source defined by the CIE based on the sensing data.

According to an embodiment, in operation 320, the display device 400 may perform color reproduction calibration corresponding to a color temperature of at least one ELS based on the first color reproduction modeling data.

The first color reproduction modeling data may include first reproduction color data of an RCP according to an illumination condition of at least one standard light source defined by the CIE. For example, the first reproduction color data may include a correlation relationship between a change in color temperature and a reproduction color by modeling a reproduction color of the RCP with respect to at least one standard light source using a predetermined measurement device 600.

As shown in FIG. 5B, at least one standard light source may include a first standard light source (SLS1) to a fifth standard light source (SLS5). For example, at least one standard light source may include at least one of CIE A, CIE F2, CIE D50, CIE D65, or CIE D75 defined by the CIE. The SLS1 is a light source with a color temperature range of 2000K to 4000K and may include CIE A. A second standard light source (SLS2) is a light source with a color temperature range of 4000K to 5000K and may include CIE F2. A third standard light source (SLS3) is a light source with a color temperature range of 5000K to 6000K and may include CIE D50. A fourth standard light source (SLS4) is a light source with a color temperature range of 6000K to 7000K and may include CIE D65. The fifth standard light source (SLS5) is a light source with a color temperature range of 7000K to 12000K and may include CIE D75.

CIE A is a standard light source having a color temperature of approximately 2856K simulating tungsten filament illumination and may be a color temperature representing an indoor lighting environment. CIE F2 is a standard light source having a color temperature of approximately 4200K simulating fluorescent lighting and may be a color temperature representing an office or commercial environment. CIE D50 is a standard light source having a color temperature of approximately 5000K simulating natural light in the morning or afternoon and may be a color temperature representing natural light in daily life. CIE D65 is a standard light source having a color temperature of approximately 6500K simulating an average daylight in Northern Europe and may be a color temperature representing natural light on a clear day. CIE D75 is a standard light source having a color temperature of approximately 7500K simulating daylight on a very clear day and may represent a high color temperature with a cool tone.

The RCP may include at least 24 color patches with different color values. The RCP may be a color checker for performing color reproduction modeling using at least 24 color patches. For example, the RCP may include at least one color patch among Light Gray, Dark Gray, Medium Gray, Light Skin, Dark Skin, Sky Blue, Green, Blue, Red, Yellow, Magenta, Cyan, Blue Green, Orange, Purple, Yellow Green, Navy Blue, Lemon, Blue Purple, Burnt Orange, Light Blue, Light Green, Lilac, or Peach. The RCP may be used to collect reproduction colors according to various standard light sources inside the measurement device 600 as shown in FIG. 6.

Color reproduction calibration may increase the color reproduction rate of the output image (IMG1) with respect to input image data by adjusting at least one of brightness, color temperature, contrast, color, saturation, or sharpness of the IMG1. For example, color reproduction calibration may change at least one adjustment value of the IMG1 so that the IMG1 accurately represents a color of the input image data.

For example, brightness adjustment may maintain an appropriate brightness level of the IMG1 by adjusting brightness of the IMG1. For example, color temperature adjustment may change an overall color tone of the IMG1 by adjusting a color temperature of the IMG1. For example, contrast adjustment may adjust a contrast between a bright portion and a dark portion of the IMG1. For example, color adjustment may enhance an overall color balance of the IMG1 by adjusting a hue and intensity of a specific color. For example, saturation adjustment may change the atmosphere of the IMG1 by adjusting an intensity of a color. For example, sharpness adjustment may make edges and detailed elements appear more distinct by changing sharpness of the IMG1.

As shown in FIG. 7, the display device 400 may display the IMG1 with an increased color reproduction rate with respect to input image data according to color reproduction calibration corresponding to a color temperature of the ELS (operation 710). For example, the display device 400 may display the IMG1 having consistent reproduction colors regardless of external illumination conditions and matching color expression with input image data by performing color reproduction calibration optimized for a color temperature of the ELS based on the first color reproduction modeling data.

Therefore, the display device 400 of the disclosure may increase color reproduction accuracy of the IMG1 by accurately reproducing a color of input image data even in various lighting environments. As a result, the display device 400 of the disclosure may provide an improved visual experience to a user.

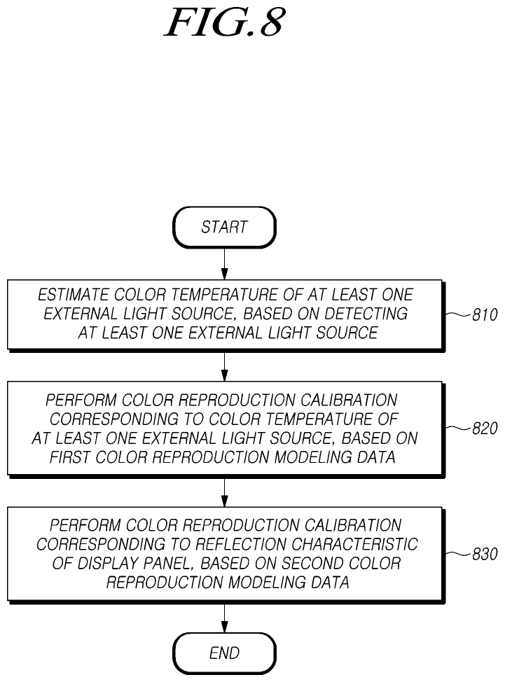

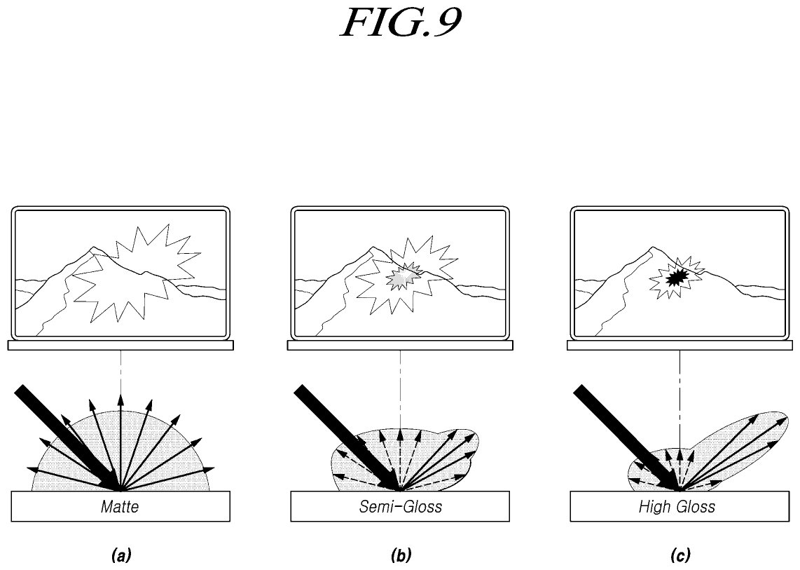

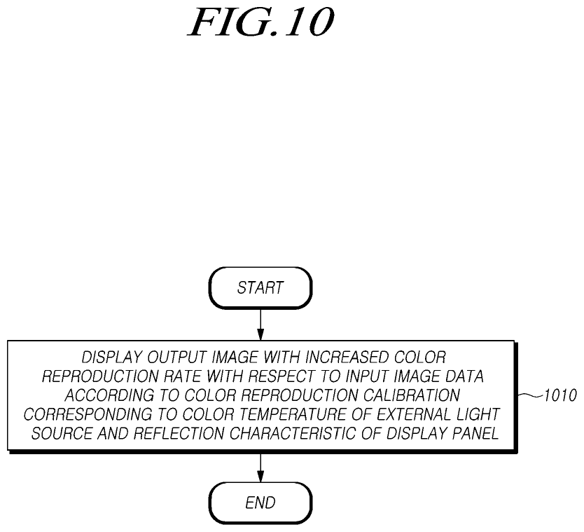

FIG. 8 illustrates an operation sequence of the display device 400 according to an embodiment of the disclosure, FIG. 9 illustrates reflection characteristics of the display device 400 according to an embodiment of the disclosure, and FIG. 10 illustrates a display operation based on color reproduction calibration according to an embodiment of the disclosure.

Referring to FIGS. 8 to 10, the display device 400 may estimate a color temperature of at least one ELS (operation 810) based on sensing at least one ELS, perform color reproduction calibration corresponding to a color temperature of at least one ELS (operation 820) based on the first color reproduction modeling data, and perform color reproduction calibration corresponding to reflection characteristics of the display panel 410 (operation 830) based on the second color reproduction modeling data.

According to an embodiment, in operation 810, the display device 400 may estimate a color temperature of at least one ELS based on detecting at least one ELS. For example, the display device 400 may display an output image based on input image data under a predetermined illumination condition. The predetermined illumination condition may include at least one ELS. At least one ELS may have a predetermined color temperature.

The display device 400 may estimate a color temperature of at least one ELS based on the sensing data. The display device 400 may estimate an area corresponding to a color of at least one ELS on a LAB color space. The LAB color space may represent brightness and color of a color on a color space implemented with an L-axis, an a-axis, and a b-axis as positional information. The L-axis may represent brightness as positional information. The a-axis and b-axis may represent a predetermined color as positional information. For example, the a-axis may represent a color ranging from green to red. For example, the b-axis may represent a color ranging from blue to yellow. The display device 400 may classify at least one ELS into at least one standard light source defined by the CIE based on the sensing data.

According to an embodiment, in operation 820, the display device 400 may perform color reproduction calibration corresponding to a color temperature of at least one ELS based on the first color reproduction modeling data.

The first color reproduction modeling data may include first reproduction color data of the RCP according to an illumination condition of at least one standard light source defined by the CIE. For example, the first reproduction color data may include a correlation relationship between a change in color temperature and a reproduction color by modeling a reproduction color of the RCP with respect to at least one standard light source using a predetermined measurement device 600.

At least one standard light source may include the SLS1 to the SLS5. For example, at least one standard light source may include at least one of CIE A, CIE F2, CIE D50, CIE D65, or CIE D75 defined by the CIE. The SLS1 is a light source with a color temperature range of 2000K to 4000K and may include CIE A. The SLS2 is a light source with a color temperature range of 4000K to 5000K and may include CIE F2. The SLS3 is a light source with a color temperature range of 5000K to 6000K and may include CIE D50. The SLS4 is a light source with a color temperature range of 6000K to 7000K and may include CIE D65. The SLS5 is a light source with a color temperature range of 7000K to 12000K and may include CIE D75.

The RCP may include at least 24 color patches with different color values. The RCP may be a color checker for performing color reproduction modeling using at least 24 color patches. The RCP may be used to collect reproduction colors according to various standard light sources inside the measurement device 600.

According to an embodiment, in operation 830, the display device 400 may perform color reproduction calibration corresponding to reflection characteristics of the display panel 410 based on the second color reproduction modeling data.

The second color reproduction modeling data may include second reproduction color data of the RCP according to the reflection characteristics of the display panel 410 under a predetermined illumination condition. For example, the second color reproduction modeling data may include a correlation relationship between reflection characteristics and reproduction color by modeling a reproduction color of the RCP for each film type reflection characteristic of the display panel 410 using display panel 410 information.

The reflection characteristics may include at least one of a reflectance of the display panel 410 or a viewing angle of the display panel 410. The reflectance of the display panel 410 and the viewing angle of the display panel 410 may change according to a film type of the display panel 410. For example, the film type of the display panel 410 may include at least one of a matte type, a semi-gloss type, or a high gloss type.

As shown in FIG. 9(a), the matte type has low reflectance and may disperse light evenly. The matte type has diffuse reflection characteristics and may minimize specular reflection. The matte type has a relatively wide viewing angle and may have a low color change rate according to an angle.

As shown in FIG. 9(b), the semi-gloss type may have a reflectance with moderate light reflection and glare. The semi-gloss type has reflection characteristics between diffuse and specular reflection, and some of the light may be directly reflected, and some may be dispersed. The semi-gloss type may have a narrower viewing angle than the matte type, but a wider viewing angle compared to the high gloss type.

As shown in FIG. 9(c), the high gloss type has high reflectance and may strongly reflect light. The high gloss type has specular reflection characteristics, and an image may be clearly reflected on the surface. The high gloss type has a relatively narrow viewing angle, and a change in color or contrast may occur according to an angle.

The second color reproduction modeling data may analyze reflection characteristics of the display panel 410 based on measuring a Specular Component Excluded (SCE) value of the display panel 410. For example, the SCE value may be a value measured for remaining light (e.g., diffuse reflected light) excluding a specular component (e.g., specular reflected light) of light reflected from a surface of the display panel 410. The SCE value may signify a color recognized by a human eye when viewed on the display panel 410. For example, the SCE value may be an indicator representing a degree to which the display panel 410 disperses light (e.g., diffuse reflection).

Color reproduction calibration may increase the color reproduction rate of the IMG1 with respect to the input image data by adjusting at least one of brightness, color temperature, contrast, color, saturation, or sharpness of the IMG1. For example, color reproduction calibration may change at least one adjustment value of the IMG1 so that the IMG1 accurately represents a color of the input image data.

For example, brightness adjustment may maintain an appropriate brightness level of the IMG1 by adjusting brightness of the IMG1. For example, color temperature adjustment may change the overall color tone of the IMG1 by adjusting the color temperature of the IMG1. For example, contrast adjustment may adjust a contrast between a bright portion and a dark portion of the IMG1. For example, color adjustment may enhance an overall color balance of the IMG1 by adjusting the hue and intensity of a specific color. For example, saturation adjustment may change the atmosphere of the IMG1 by adjusting the intensity of a color. For example, sharpness adjustment may make edges and detailed elements appear more distinct by changing sharpness of the IMG1.

In an embodiment, the display device 400 may perform color reproduction calibration based on at least one of the first color reproduction modeling data or the second color reproduction modeling data. For example, the display device 400 may classify the ELS into at least one standard light source and adjust at least one of brightness, color temperature, contrast, color, saturation, or sharpness of the IMG1 so that a color of input image data is accurately represented at a color temperature of the ELS based on the first color reproduction modeling data. For example, the display device 400 may adjust at least one of brightness, color temperature, contrast, color, saturation, or sharpness of the IMG1 so that a color of input image data is accurately represented according to an SCE value of the display panel 410 based on the second color reproduction modeling data.

As shown in FIG. 10, the display device 400 may display an output image with an increased color reproduction rate with respect to input image data according to color reproduction calibration corresponding to a color temperature of the ELS and reflection characteristics of the display panel 410 (operation 1010). For example, the display device 400 may display an output image having consistent reproduction colors regardless of external illumination conditions and matching color expression with input image data by performing color reproduction calibration optimized for a color temperature of the ELS based on the first color reproduction modeling data. For example, the display device 400 may display an output image having consistent reproduction colors regardless of the SCE value of the display panel 410 and matching color expression with input image data by performing color reproduction calibration optimized for reflection characteristics of the display panel 410 based on the second color reproduction modeling data.

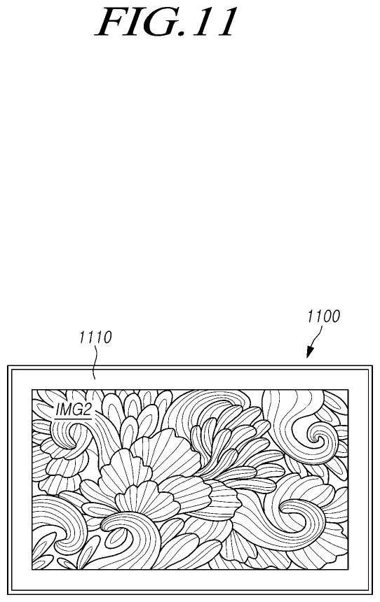

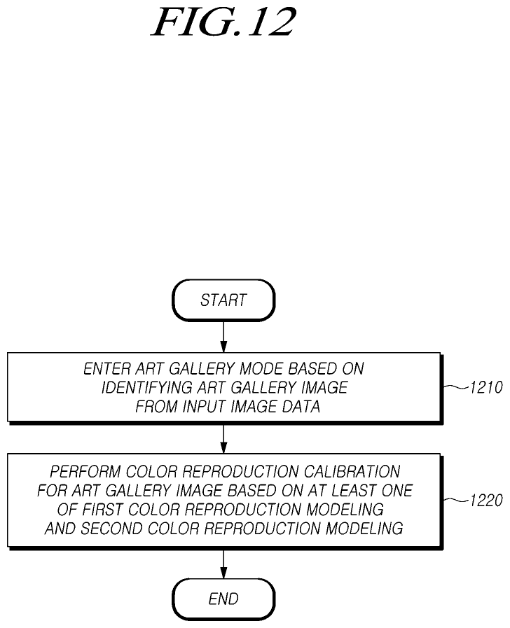

FIG. 11 illustrates an art gallery mode of the display device 1100 according to an embodiment of the disclosure, and FIG. 12 illustrates an operation sequence of the display device 1100 when automatically entering the art gallery mode.

Referring to FIG. 11, the display device 1100 may operate in an art gallery mode. The art gallery mode may perform color reproduction calibration to accurately and vividly reproduce colors of artwork or high-quality images in case displaying the art gallery image on the display device 1100. For example, the art gallery mode may delicately adjust color, saturation, brightness, and white balance to accurately display the original colors and textures of artwork or high-quality images. In other words, the art gallery mode may be an advanced function designed for users who prioritize details of artwork or high-quality images. For example, the art gallery mode may perform color reproduction calibration optimized for artwork or high-quality images included in the input image data.

Referring to FIG. 12, the display device 1100 may enter the art gallery mode based on identifying an art gallery image from the input image data (operation 1210) and perform the color reproduction calibration for the art gallery image based on at least one of the first color reproduction modeling data or the second color reproduction modeling data (operation 1220).

As an example, in operation 1210, the display device 1100 may enter the art gallery mode based on identifying an art gallery image from the input image data. For example, the display device 1100 may determine whether the input image data includes an art gallery image. For example, the display device 1100 may identify an art gallery image using an artificial intelligence model configured with a plurality of artificial neural networks. The artificial neural network may include a deep neural network (DNN). For example, the artificial neural network may include at least one of a convolutional neural network (CNN), DNN, recurrent neural network (RNN), restricted Boltzmann machine (RBM), deep belief network (DBN), bidirectional recurrent deep neural network (BRDNN), or deep Q-networks. In the event that the display device 1100 determines that an art gallery image is included in the input image data, the display device 1100 may automatically enter the art gallery mode.

As an example, in operation 1220, the display device 1100 may perform the color reproduction calibration for the art gallery image based on at least one of the first color reproduction modeling data or the second color reproduction modeling data. For example, the display device 1100 may classify the ELS as at least one standard light source, and adjust at least one of brightness, color temperature, contrast, color, saturation, or sharpness of the output image (IMG1) such that the color of the art gallery image is accurately represented at the color temperature of the ELS based on the first color reproduction modeling data. For example, the display device 1100 may adjust at least one of brightness, color temperature, contrast, color, saturation, or sharpness of the output image (IMG1) such that the color of the art gallery image is accurately represented according to the SCE value of the display device 1110 based on the second color reproduction modeling data.

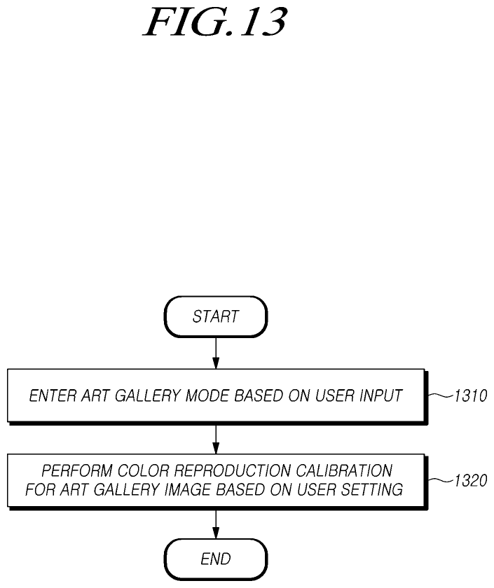

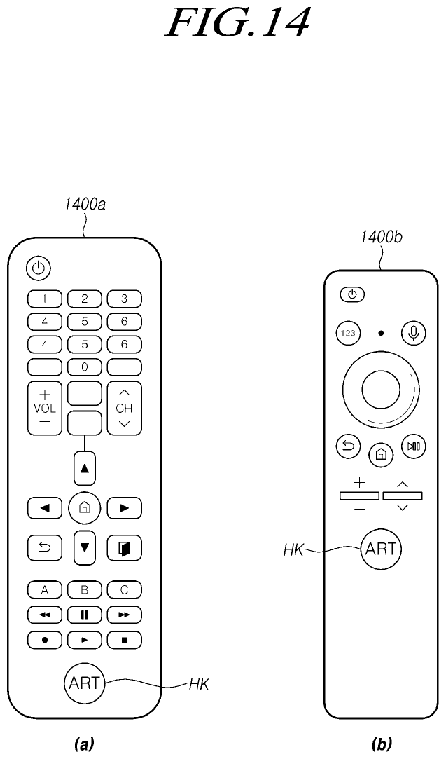

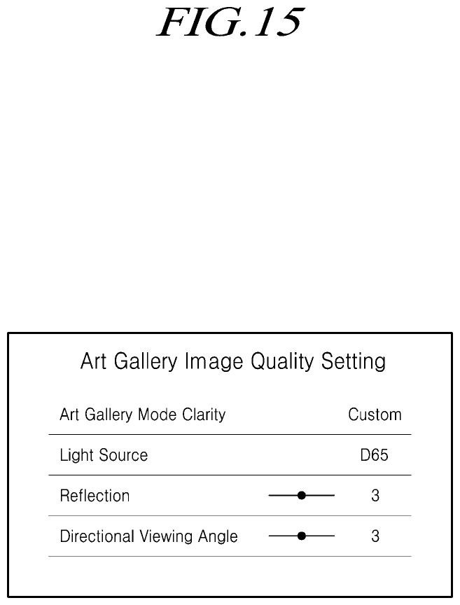

FIG. 13 illustrates an operation sequence of the display device 1100 when manually entering the art gallery mode, FIG. 14 illustrates a control device controlling the display device 1100 according to an embodiment of the disclosure, and FIG. 15 illustrates a user interface of the display device 1100 according to an embodiment of the disclosure.

Referring to FIG. 13, the display device 1100 may enter the art gallery mode based on a user input (operation 1310) and perform the color reproduction calibration for the art gallery image based on a user setting (operation 1320).

As an example, in operation 1310, the display device 1100 may enter the art gallery mode based on a user input. For example, the display device 1100 may receive a user input requesting to enter the art gallery mode. For example, the user may transmit a user input to the display device 1100 via at least one of a physical button (e.g., a switch, a key), a touch screen interface, a voice command, a mobile application, or a remote controller.

In an embodiment, the display device 1100 may receive the user input from an external control device (1400a, 1400b). For example, as shown in FIG. 14 (a), the control device 1400a may be a universal remote controller. For example, as shown in FIG. 14 (b), the control device 1400b may be a smart remote controller. The control device (1400a, 1400b) may include a hot key for entering the art gallery mode. For example, the user may transmit a user input requesting to enter the art gallery mode to the display device 1100 using the hot key of the control device (1400a, 1400b). In this case, the display device 1100 may enter the art gallery mode based on the user input received from the control device (1400a, 1400b).

As an example, in operation 1320, the display device 1100 may perform the color reproduction calibration for the art gallery image based on a user setting. For example, the color reproduction calibration may increase the color reproduction rate of the art gallery image of the output image (IMG1) by adjusting at least one of brightness, color temperature, contrast, color, saturation, or sharpness of the output image (IMG1) based on the user setting.

In an embodiment, the display device 1100 may provide a user interface for changing a user setting. For example, as shown in FIG. 15, the display device 1100 may provide a user interface for changing the user setting including at least one of clarity of the art gallery mode (Art Gallery Mode Clarity), light source type (Light Source), reflectance (Reflection), or directional viewing angle (Directional Viewing Angle). The user may change at least one of the setting of clarity, light source type, reflectance, or viewing angle of the gallery mode via the user interface.

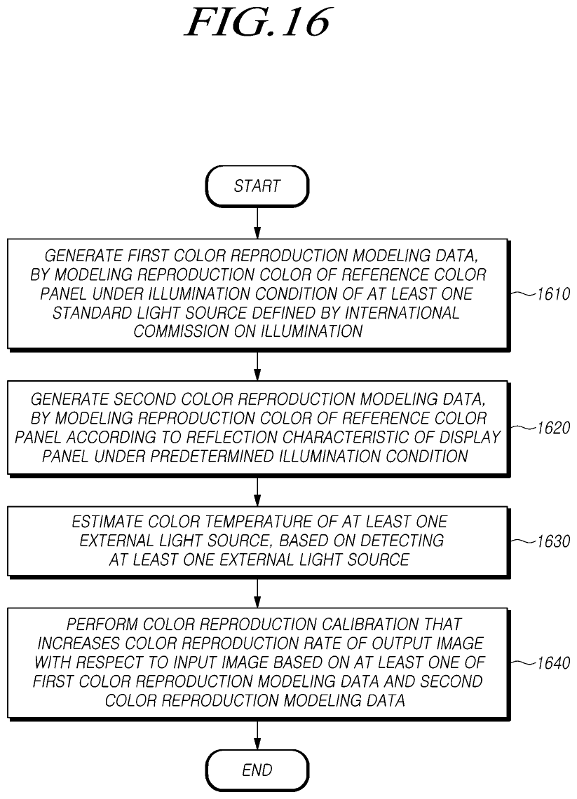

FIG. 16 illustrates an image processing method for color reproduction calibration according to an embodiment of the disclosure.

Referring to FIG. 16, the image processing method of the disclosure may generate first color reproduction modeling data (operation 1610) by modeling reproduction colors according to a type of light source, generate second color reproduction modeling data (operation 1620) by modeling reproduction colors according to reflection characteristics of the display panel 410, estimate a color temperature of at least one ELS (operation 1630) based on detecting at least one ELS, and perform color reproduction calibration (operation 1640) for increasing a color reproduction rate of the output image with respect to the input image data.

As an example, in operation 1610, the image processing method may generate first color reproduction modeling data by modeling reproduction colors according to a type of light source. For example, the first color reproduction modeling data may include first reproduction color data of the RCP according to illumination conditions of at least one standard light source defined by the CIE. For example, the image processing method may generate first reproduction color data including a correlation between a change in color temperature and reproduction color by modeling reproduction color of the RCP for at least one standard light source using a predetermined measurement device 600. For example, at least one standard light source may include at least one of CIE A, CIE F2, CIE D50, CIE D65, and CIE D75 defined by the CIE. The RCP may be a color checker for performing color reproduction modeling using at least 24 color patches.

As an example, in operation 1620, the image processing method may generate second color reproduction modeling data by modeling reproduction colors according to reflection characteristics of the display panel 410. For example, the second color reproduction modeling data may include second reproduction color data of the RCP according to the reflection characteristics of the display panel 410 under a predetermined illumination condition. For example, the image processing method may generate second color reproduction modeling data, which includes a correlation between reflection characteristics and reproduction color, by modeling reproduction color of the RCP with respect to reflection characteristics per film type of the display panel 410 using display panel 410 information.

In an embodiment, the display panel 410 information may include a specular component excluded (SCE) value of the display panel 410. For example, the SCE value may be a value measuring remaining light (e.g., diffuse reflection light), excluding a specular component (e.g., specular reflection light) of light reflected from the surface of the display panel 410.

In an embodiment, the reflection characteristics may include at least one of reflectance of the display panel 410 or a viewing angle of the display panel 410. The reflectance of the display panel 410 and the viewing angle of the display panel 410 may change according to a film type of the display panel 410. For example, the film type of the display panel 410 may include at least one of a matte type, a semi-gloss type, or a high gloss type.

As an example, in operation 1630, the image processing method may estimate a color temperature of at least one ELS based on detecting at least one ELS. For example, the image processing method may estimate a color temperature of at least one ELS based on the sensing data. The image processing method may estimate an area corresponding to a color of at least one ELS in a LAB color space. The LAB color space may represent brightness and color of a color as positional information on a color space implemented with an L-axis, an a-axis, and a b-axis. The L-axis may represent brightness as positional information. The a-axis and b-axis may represent a predetermined color as positional information. For example, the a-axis may represent a color ranging from green to red. For example, the b-axis may represent a color ranging from blue to yellow. The image processing method may classify at least one ELS as at least one standard light source defined by the CIE based on the sensing data.

As an example, in operation 1640, the image processing method may perform color reproduction calibration for increasing a color reproduction rate of the output image with respect to the input image data. For example, the image processing method may adjust at least one of brightness, color temperature, contrast, color, saturation, or sharpness of the output image based on at least one of the first color reproduction modeling data or the second color reproduction modeling data.

For example, brightness adjustment may maintain the output image at an appropriate brightness level by adjusting brightness of the output image. For example, color temperature adjustment may change the overall color tone of the output image by adjusting the color temperature of the output image. For example, contrast adjustment may adjust a contrast between bright and dark portions of the output image. For example, color adjustment may improve the overall color balance of the output image by adjusting a hue and intensity of a specific color. For example, saturation adjustment may change an atmosphere of the output image by adjusting the intensity of a color. For example, sharpness adjustment may make edges and details more distinct by changing sharpness of the output image.

In an embodiment, the display device 400 may perform color reproduction calibration based on the estimated color temperature of the at least one ELS and at least one of the first color reproduction modeling data or the second color reproduction modeling data. For example, the display device 400 may classify the at least one ELS as at least one standard light source, and adjust at least one of brightness, color temperature, contrast, color, saturation, or sharpness of the output image such that colors of the input image data are accurately represented at the color temperature of the at least one ELS based on the first color reproduction modeling data. For example, the display device 400 may adjust at least one of brightness, color temperature, contrast, color, saturation, or sharpness of the output image such that colors of the input image data are accurately represented according to the SCE value of the display panel 410 based on the second color reproduction modeling data.

In this manner, the image processing method of the disclosure may detect a color temperature of the at least one ELS and adaptively perform image quality adjustment according to the color temperature of the at least one ELS. Further, the image processing method of the disclosure may perform image quality adjustment optimized for reflection characteristics of the display panel.

Accordingly, the image processing method of the disclosure may increase color reproduction accuracy of the output image by accurately reproducing colors of the input image data even in various illumination environments. As a result, the image processing method of the disclosure may provide improved visual experience to the user. However, since the foregoing has been described above, redundant descriptions thereof are omitted.

The display device according to various embodiments disclosed herein may be various types of devices. The display device may include, for example, a portable communication device (e.g., a smart phone), a computer device, a portable multimedia device, a portable medical device, a camera, a wearable device, or a home appliance. The display device according to an embodiment of the present document is not limited to the aforementioned devices.

Various embodiments of the present document and terminology used therein are not intended to limit the technical features described in the present document to specific embodiments, and should be understood to include various changes, equivalents, or replacements of the corresponding embodiment. With reference to the description of the drawings, similar reference signs may be used for similar or related components. The singular form of a noun corresponding to an item may include one or more of the corresponding item, unless the context clearly indicates otherwise. In this document, each of phrases such as “A or B,” “at least one of A and B,” “at least one of A or B,” “A, B, or C,” “at least one of A, B, and C,” and “at least one of A, B, or C” may include any one of the items listed together in the corresponding phrase, or all possible combinations thereof. Terms such as “first,” “second,” or “first” or “second” may be used merely to distinguish the corresponding component from another corresponding component, and do not limit the corresponding components in other aspects (e.g., importance or order). When any (e.g., first) component is referred to as “coupled” or “connected” to another (e.g., second) component, with or without the terms “functionally” or “communicatively,” it means that any component may be directly connected (e.g., wired), wirelessly, or through a third component to the other component.

The term “module” used in various embodiments of the present document may include a unit implemented in hardware, software, or firmware, and may be used interchangeably with terms such as logic, logic block, component, or circuit, for example. A module may be a minimum unit or a part thereof that is integrally configured or performs one or more functions. For example, according to an embodiment, a module may be implemented in the form of an application-specific integrated circuit (ASIC).

Various embodiments of the present document may be implemented as software (e.g., a program) including one or more instructions stored in a storage medium (e.g., an internal memory or an external memory) readable by a device (machine) (e.g., an electronic device). For example, a processor of a device (e.g., an electronic device) may call at least one instruction from one or more instructions stored in the storage medium and execute it. This enables the device to be operated to perform at least one function according to at least one called instruction. The one or more instructions may include code generated by a compiler or code executable by an interpreter. A storage medium readable by a device may be provided in the form of a non-transitory storage medium. Here, “non-transitory” merely means that the storage medium is a tangible device and does not include a signal (e.g., electromagnetic waves), and does not distinguish between cases where data is stored semi-permanently in the storage medium and cases where data is stored temporarily.

According to an embodiment, the method according to various embodiments disclosed in the present document may be provided by being included in a computer program product. The computer program product may be traded between a seller and a buyer as a commodity. The computer program product may be distributed in the form of a device-readable storage medium (e.g., compact disc read only memory (CD-ROM)), or may be distributed online (e.g., downloaded or uploaded) via an application store (e.g., Play Store™) or directly between two user devices (e.g., smart phones). In the case of online distribution, at least a part of the computer program product may be temporarily stored or temporarily generated in a device-readable storage medium such as a memory of a server of a manufacturer, a server of an application store, or a relay server.

According to various embodiments, each of the aforementioned components (e.g., module or program) may include one or more entities, and some of the plurality of entities may be separately disposed in different components. According to various embodiments, one or more of the aforementioned corresponding components or operations may be omitted, or one or more other components or operations may be added. Alternatively or additionally, a plurality of components (e.g., module or program) may be integrated into one component. In this case, the integrated component may perform one or more functions of each of the plurality of components in the same or similar manner as performed by the corresponding component among the plurality of components before the integration. According to various embodiments, operations performed by a module, program, or other component may be executed sequentially, in parallel, repetitively, or heuristically, or one or more of the operations may be executed in a different order, omitted, or one or more other operations may be added.

What is claimed is:

1. A display device, comprising:
memory storing one or more instructions; and
at least one processor connected to the memory,
wherein the one or more instructions, when executed by the at least one processor individually or collectively, cause the display device to:
estimate a color temperature of at least one external light source, based on detecting the at least one external light source; and
perform, based on first color reproduction modeling data and the color temperature of the at least one external light source, a color reproduction calibration by adjusting at least one of brightness, color temperature, contrast, color, saturation, or sharpness of an output image, obtaining the output image having a color reproduction rate that is increased relative to input image data.

2. The display device of claim 1, wherein the first color reproduction modeling data comprises first reproduction color data of a reference color panel, the first reproduction color data corresponding to an illumination condition of at least one standard light source defined by the International Commission on Illumination (CIE).

3. The display device of claim 2, wherein the at least one standard light source comprises at least one of CIE A, CIE F2, CIE D50, CIE D65, or CIE D75.

4. The display device of claim 2, wherein the reference color panel comprises at least 24 color patches having different color values from each other.

5. The display device of claim 2, wherein the one or more instructions, when executed by the at least one processor individually or collectively, further cause the display device to:
perform, based on a reflection characteristic of a display panel and second color reproduction modeling data, a color reproduction calibration,
wherein the second color reproduction modeling data comprises second reproduction color data of the reference color panel, the second reproduction color data corresponding to the reflection characteristic of the display panel under a predetermined illumination condition.

6. The display device of claim 5, wherein the reflection characteristic comprises at least one of a reflectance or a viewing angle of the display panel.

7. The display device of claim 5, wherein the one or more instructions, when executed by the at least one processor individually or collectively, further cause the display device to:
enter an art gallery mode based on identifying an art gallery image from the input image data; and
perform the color reproduction calibration for the art gallery image based on at least one of the first color reproduction modeling data or the second color reproduction modeling data.

8. The display device of claim 2, wherein the one or more instructions, when executed by the at least one processor individually or collectively, further cause the display device to:
enter an art gallery mode based on a user input; and
perform the color reproduction calibration for an art gallery image based on a user setting.

9. The display device of claim 8, wherein the one or more instructions, when executed by the at least one processor individually or collectively, further cause the display device to receive the user input from an external control device, and wherein the external control device comprises a hot-key for entering the art gallery mode.

10. The display device of claim 8, wherein the one or more instructions, when executed by the at least one processor individually or collectively, further cause the display device to provide a user interface for changing the user setting of the art gallery mode, the user setting comprising at least one of a sharpness, a light source type, a reflectance, or a viewing angle.

11. An image processing method for color reproduction calibration, the method comprising:
generating first color reproduction modeling data, by modeling a reproduction color according to a type of light source;
generating second color reproduction modeling data, by modeling a reproduction color according to a reflection characteristic of a display panel;
estimating a color temperature of at least one external light source, based on detecting the at least one external light source; and
performing, based on the estimated color temperature of the at least one external light source and at least one of the first color reproduction modeling data or the second color reproduction modeling data, a color reproduction calibration by adjusting at least one of brightness, color temperature, contrast, color, saturation, or sharpness of an output image, obtaining the output image having a color reproduction rate that is increased relative to an input image data.

12. The image processing method of claim 11, wherein the generating of the first color reproduction modeling data comprises modeling a reproduction color of a reference color panel, the first color reproduction modeling data including first reproduction color data corresponding to an illumination condition of at least one standard light source defined by the International Commission on Illumination (CIE).

13. The image processing method of claim 12, wherein the at least one standard light source comprises at least one of CIE A, CIE F2, CIE D50, CIE D65, or CIE D75.

14. The image processing method of claim 12, wherein the reference color panel comprises at least 24 color patches having different color values from each other.

15. The image processing method of claim 12, wherein the generating of the second color reproduction modeling data comprises modeling a reproduction color of the reference color panel, the second color reproduction modeling data including second reproduction color data corresponding to the reflection characteristic of the display panel under a predetermined illumination condition.

16. The image processing method of claim 15, wherein the reflection characteristic comprises at least one of a reflectance of the display panel and a viewing angle of the display panel.

17. The image processing method of claim 12, wherein the performing of the color reproduction calibration comprises:
entering an art gallery mode based on identifying an art gallery image from the input image data; and
performing, based on the estimated color temperature of the at least one external light source and at least one of the first color reproduction modeling data or the second color reproduction modeling data, the color reproduction calibration for the art gallery image.

18. The image processing method of claim 12, wherein the performing of the color reproduction calibration comprises:
entering an art gallery mode based on a user input; and
performing the color reproduction calibration for the art gallery image based on a user setting.

19. The image processing method of claim 18, wherein the entering the art gallery mode based on the user input comprises receiving the user input from an external control device, and
wherein the external control device comprises a hot-key for entering the art gallery mode.

20. The image processing method of claim 18, further comprising providing a user interface for changing the user setting, the user setting comprising at least one of sharpness of the art gallery mode, a type of light source, a reflectance, or a viewing angle.
